(19) United States
(12) Patent Application Publication
(10) Pub. No.: US 2022/0166799 A1
(43) Pub. Date: May 26, 2022

(54) LEVERAGING 5G NETWORK SLICING CAPABILITY TO INCREASE NETWORK SECURITY

(71) Applicant: AT&T Intellectual Property I, L.P., Atlanta, GA (US)

(72) Inventors: Carolyn Roche Johnson, Holmdel, NJ (US); Xiaowen Mang, Morganville, NJ (US); Yaron Koral, Cherry Hill, NJ (US)

(21) Appl. No.: 17/104,604

(22) Filed: Nov. 25, 2020

(51) Int. Cl. H04L 29/06; H04W 28/06; H04W 8/26; G06F 21/55; G06F 21/57

(52) U.S. Cl. CPC H04L 63/20; H04W 28/06; G06F 2221/034; G06F 21/554; G06F 21/57; H04W 8/26

(57) ABSTRACT

Architectures and techniques are presented that improve or increase network security for networks that have network slicing capability. In addition to (or instead of) conventional network slices, various security-based network slices can be defined and/or implemented. Network traffic of a subscriber device can be assigned to one of these security based network slices. Assignment can be based on characteristics of the subscriber device and/or based on the current behavior or role of the subscriber device. Further, in response to determining that a behavior of the subscriber device satisfies a criterion (e.g., a criterion relating to malfeasance or misbehavior, a criterion relating to switching to a maintenance cycle, and so on), reassigning network traffic of the subscriber device from the currently assigned network slice to a different network slice.

### TECHNICAL FIELD

The present application relates generally to leveraging a network slicing capability of a host network to improve security, and more particularly to utilizing the network slicing to perform security techniques.

### BACKGROUND

Conventional mobile networks such as 2G, 3G, and 4G, holistically relied upon a one-size-fits-all model to serve all subscribers. In contrast, 5G has taken a market-based approach by recognizing that different subscribers can have very different demands and use profiles. For example, machine-to-machine communication is very different from communication by subscriber devices that expect ultra reliable low latency communication, both of which are very different from communication according to enhanced mobile broadband communication. In other words, subscriber devices have a wide range of demands or expectations in terms of throughput, latency, or any quality of service (QoS) metric.

In order to address this wide range of demands, 5G has introduced the concept of network slicing, which enables multiplexing of virtualized and independent logical networks on the same physical network infrastructure. Thus, each network slice is an isolated, end-to-end network that can be tailored to fulfill diverse requirements. For example, a first slice can be configured for devices that have subscribed to ultra reliability and low latency, while a second slice can be configured for devices that have subscribed to a different QoS tier or those that have a different set of demands or expectations. Because each slice is isolated from other slices, issues such as overutilization in one slice does not affect the QoS of another slice.

### BRIEF DESCRIPTION OF THE DRAWINGS

Numerous aspects, embodiments, objects and advantages of the present application will be apparent upon consideration of the following detailed description, taken in conjunction with the accompanying drawings, in which like reference characters refer to like parts throughout, and in which:

FIG. 1 depicts a block diagram of an example network architecture that is capable of network slicing in accordance with certain embodiments of this disclosure;

FIG. 2 shows a block diagram illustrating example concepts of network slicing in accordance with certain embodiments of this disclosure;

FIG. 3 illustrates a block diagram of an example system or device that can provide increased security for a network that has network slicing capabilities in accordance with certain embodiments of this disclosure;

FIG. 4 shows illustration 400 depicting an example of various logical network slices in accordance with certain embodiments of this disclosure;

FIG. 5 shows a block diagram illustrating additional aspects or elements of the security device in accordance with certain embodiments of this disclosure;

FIG. 6 illustrates an example method that can provide increased security for a network that has network slicing capabilities in accordance with certain embodiments of this disclosure;

FIG. 7 illustrates an example method that can provide for additional elements or aspects in connection with increased security for a network that has network slicing capabilities in accordance with certain embodiments of this disclosure;

FIG. 8 illustrates a first example of a wireless communications environment with associated components that can be operable to execute certain embodiments of this disclosure;

FIG. 9 illustrates a second example of a wireless communications environment with associated components that can be operable to execute certain embodiments of this disclosure; and

FIG. 10 illustrates an example block diagram of a computer operable to execute certain embodiments of this disclosure.

### DETAILED DESCRIPTION

### Overview

As noted above, the concept of network slicing is proposed for implementation in 5G. Network slicing, in which the same physical network infrastructure serves multiple isolated and independent logical networks or slices, is used in 5G to meet various QoS demand metrics. This disclosure proposes that, in addition to using the network slicing capabilities of 5G for conventional purposes, to further leverage the network slicing capability to facilitate additional security techniques. It is understood that while 5G is used as an example, any network architecture that has the capability to implement the relevant concepts of network slicing can be used in connection with the disclosed techniques. Such can apply to networks that already support network slicing or networks that can be configured to support network slicing, e.g., via network functions virtualization or other suitable techniques.

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

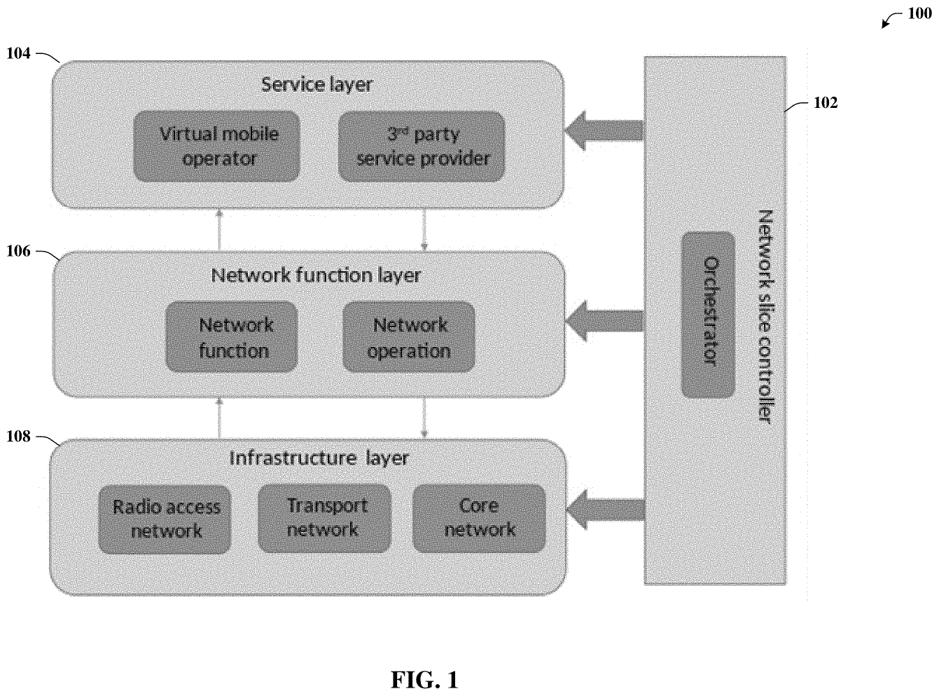

Referring now to the drawings, with initial reference to FIG. 1, system 100 is depicted, showing a block diagram of an example network architecture that is capable of network slicing in accordance with certain embodiments of this disclosure. Network slicing-capable networks (e.g., 5G architectures) will typically have a network slice controller 102, which is sometimes referred to as an orchestrator. In 5G networks, a network slice selection function (NSSF) and may represent network slice controller 102. Regardless of the implementation, however, network slice controller 102 can interface with various layers such as service layer 104, network function layer 106, and infrastructure layer 108. Such can advantageously allow efficient and flexible slice creation that can be reconfigured on the fly. It is appreciated that in current literature, the 5G NSSF is designed to select slices, but does not create slices, so such functionality can be performed by other devices.

In general, network slice controller 102 manages and coordinates functions performed by layers 104-108. By way of example, network slice controller 102 can perform end-to-end service management, which can entail mapping various service instances expressed in terms of service level agreements (SLA) with suitable virtualized network functions capable of satisfying network service constraints. Network slice controller 102 can further function to provide virtual resources definitions. For example, virtualization of the physical network resources can be managed in order to simplify the resources management operations performed when allocating network functions. Network slice controller 102 can also perform slice life-cycle management. For instance, slice performance monitoring across layers 104-108 can be performed in order to dynamically reconfigure each slice to accommodate different SLA requirements changes or updates.

Service layer 104 can interface with virtual mobile operators and/or third party service providers that share the same underlying physical network, which can provide a unified vision of the service requirements. Each service can be formally represented as a service instance that can embed all the network characteristics in the form of SLA requirements that are expected to be fully satisfied by a suitable slice.

Network function layer 106 can manage creation and termination of each network slice according to service instance requests received from service layer 104. Network function layer 106 can be composed of a set of network functions that embody well-defined behaviors and interfaces. Multiple network functions can be placed over the virtual network infrastructure and chained together to create an end-to-end network slice instance that reflects the network characteristics requested by service layer 104.

Infrastructure layer 108 can represent the actual physical network devices such as radio access network devices, transport network devices, core network devices, and so forth. The various network slices can be multiplexed upon the infrastructure layer 108 physical devices and can further provide the physical network resources to host the several network functions of each network slice. It is appreciated that infrastructure layer 108 can further comprise physical resources such as data centers for computation and storage as well as switches or routers that convey traffic.

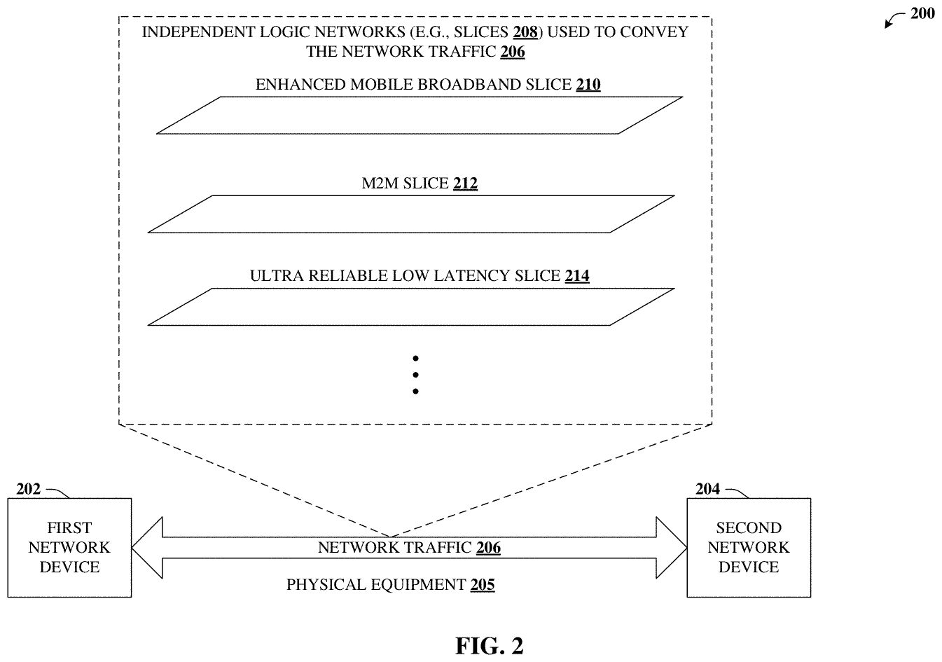

FIG. 2 depicts system 200. System 200 is an example block diagram illustrating concepts of network slicing in accordance with certain embodiments of this disclosure. It is appreciated that due to the architecture detailed in FIG. 1, slice isolation can be effectuated even while the various slices can share the same physical equipment 205 and/or infrastructure layer 108. For example, consider network traffic 206 that is propagated between two physical devices, denoted first network device 202 and second network device 204. Even though network traffic may rely on the same underlying physical equipment 205, such can be propagated via different independent logical networks, which are denoted slices 208. Typical examples described in 5G are enhanced mobile broadband slice 210 that provides defined QoS metrics, M2M slice 212, which defines very different QoS metrics, ultra reliable low latency slice 214, which defines still different QoS metrics.

Because, for example, slice 210 is isolated and independent of slice 212, it is appreciated that events or issues that occur in one slice do not affect network traffic 206 conveyed via slice 212. As such, certain aspects of security are built into the architectural design. However, even though misbehaving devices in, say, the M2M slice 212 are not likely to affect communication in the enhanced mobile broadband slice 210, there is still the potential for misbehaving devices in the M2M slice 210 to affect the communication of other devices within the M2M slice 212. The disclosed techniques propose to build on this architecture to provide more comprehensive security techniques apart from those that already exist in the architectural design of 5G and other network-slicing-capable networks.

One aspect of network security is providing defense against malicious attacks, such as distributed denial of service (DDoS) attacks. In other networks (e.g., a wide area network such as the Internet), such attacks may originate from one or more remote servers, and there are many known techniques to mitigate such attacks. However, in the context of a cellular network, such attacks are particularly problematic because devices using the network are subscribers to the network and therefore, certain remedies (e.g., blocking all traffic from the offending device or address) utilized by other networks are not available to the cellular operator, because the subscribers are typically contractually guaranteed connectivity and/or certain QoS metrics.

With the rapid growth in recent years of Internet-of-Things (IoT) devices, referred to herein as machine-to-machine (M2M) devices, the threat of DDoS attacks is higher than ever. For example, consider the case in which hundreds, thousands, or even more M2M devices that communicate via a cellular network are infected with a virus or other malicious code. Such poses a significant security threat to a mobile carrier infrastructure, for example, in the form of overloading the control plane and using signaling storms that result eventually with DDoS of the network and wide outages. Even if the issue is identified quickly, typically, the mobile carrier is not permitted to simply block traffic from the misbehaving devices due to SLA or other contractual agreements with the subscriber.

Techniques proposed herein relate to isolating, via the network slicing capability, the resources of different classes of subscriber devices based on behavior such as suspicious or malicious behavior from a network security perspective. As noted, the concept of network slicing is part of 5G to allow an operator to virtually slice the network resources according to market demand for QoS. Techniques disclosed herein propose to generate additional security slices such that an attack outbreak that takes place in one slice does not affect the other slices. The rollout of 5G technology is expected to open the opportunity for billions of M2M devices to be connected to the network. Thus, it is important to have a mechanism that protects the network from potential threats posed by these devices.

### Example Systems

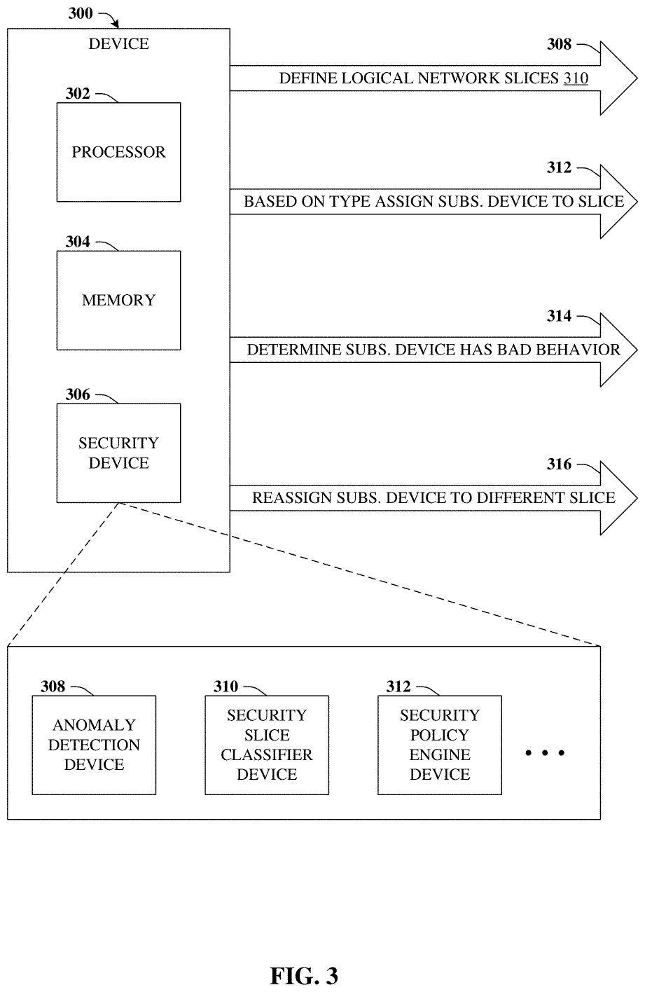

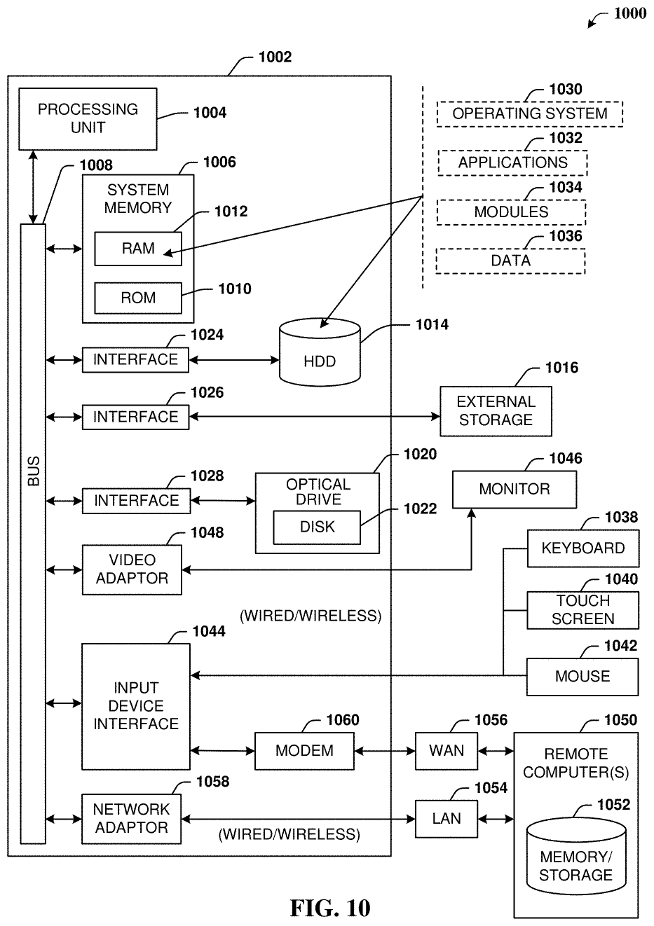

Referring now to FIG. 3, device 300 is depicted. Device 300 can provide increased security for a network that has network slicing capabilities in accordance with certain embodiments of this disclosure. Device 300 can comprise a processor 302 that can be specifically configured to perform a network planning procedure in connection with a physical space and a memory 304 that stores executable instructions that, when executed by the processor, facilitate performance of operations. Device 300 can comprise security device 306 that can be specifically tailored to leverage the network slicing capability of the underlying network to provide increased security. Processor 302 can be a hardware processor having structural elements known to exist in connection with processing units or circuits, with various operations of processor 302 being represented by functional elements shown in the drawings herein that can require special-purpose instructions, for example stored in memory 304 and/or network planning component 306. Along with these special-purpose instructions, processor 302 and/or device 300 can be a special-purpose device. Further examples of the memory 304 and processor 302 can be found with reference to FIG. 10. It is to be appreciated that device 300 or computer 1002 can represent a server device of a communications network or a user equipment device and can be used in connection with implementing one or more of the systems, devices, or components shown and described in connection with FIG. 3 and other figures disclosed herein.

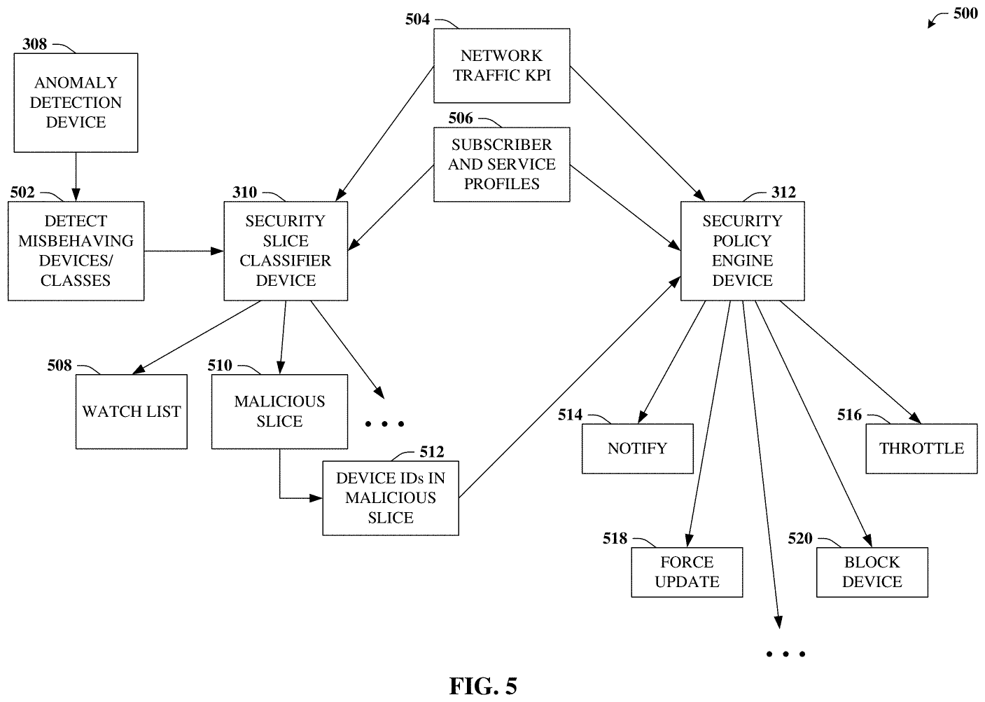

As introduced above, device 300 and/or processor 302 can be configured to provide increased security for a network that has network slicing capabilities. Such can be accomplished in conjunction with security device 306, which can represent or include several special-purpose devices such as, for example, anomaly detection device 308, security slice classifier device 310, security policy engine device 312, and so forth, all of which are further with reference to FIG. 5. Further operations performed by device 300 and/or processor 302 can comprise the following acts or procedures.

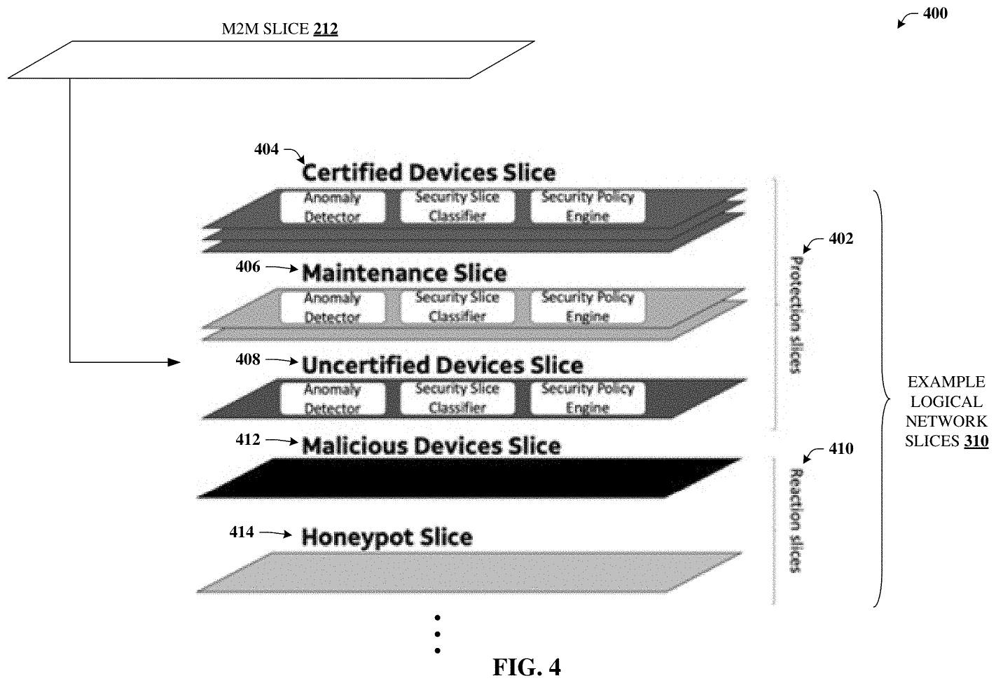

At reference numeral 308, logical network slices 310 can be defined. It is appreciated that logical network slices 310 can be distinct from slices 208 (e.g., enhanced mobile broadband slice 210, M2M slice 212, ultra reliable low latency slice 214, . . . ) discussed in connection with FIG. 2. Those slices 208 are typically defined by the network operator based on service demands In contrast, logical network slices 310 can be defined to provide additional security, examples of which are provided with reference to FIG. 4.

While still referring to FIG. 3, but turning as well to FIG. 4, illustration 400 depicts an example of logical network slices 310 in accordance with certain embodiments of this disclosure. Logical network slices 310 can be used by the network operator instead of slices 208 or in addition to slices 208. For example, all or a portion of slices 208 can be respectively composed of one or more instances of logical network slices 310. FIG. 4 shows an example of the M2M slice 212 (defined as one of the several slices 208) being composed of an example set of logical network slices 310. In other words, techniques disclosed herein can be integrated with existing network design, such that logical network slices 310 can be used with each one of the slices 208 or with a subset of slices such as used with the M2M slice 212 as in the instant example.

Consistent with previous discussion, any slice, of the logical network slices 310, can represent a virtualized logical network that is isolated from, and independent of, other slices of logical network slices 310. As such, even though all logical network slices 310 utilize the same physical equipment (e.g., physical equipment 205), each respective one of the logical network slices 310 can function independently such that operation does not affect other slices, which can be a significant advantage in terms of security. Hence, it is no longer the case that misbehaving subscriber device(s) allocated to the M2M slice 212 can negatively affect the service all other subscriber devices assigned to the M2M slice 212. Rather, said misbehaving subscriber devices(s) can at most only affect service of other subscriber devices with which it shares one of the logical network slices 310.

Accordingly, the addition of logical network slices 310 alone can dramatically reduce the impact of DDoS attacks or other signaling storm events. However, in addition, that impact can be further reduced defining one or more slices (of logical network slices 310) specifically for the misbehaving subscriber devices as is further detailed below. Briefly, it is noted here that, regardless of their type or nature, the individual slices of logical network slices 310 can typically be categorized into two classes, namely a protection slice class 402, which can handle traffic or other communication of subscriber devices that are determined to be functioning nominally or as predicted, and a reaction slice class 410, which can handle traffic or other communication of subscriber devices that are determined to be misbehaving (e.g., behaving in a malicious or suspicious manner).

Subsequent to defining 308 logical network slices 310, device 300 can, as illustrated by reference numeral 312, assign a subscriber device to the first slice. This assignment can be based on a type of the subscriber device. For example, the subscriber device can be assigned to one of the defined slices of logical network slices 310 because it is determined to be an M2M device, e.g., an IoT device such as an appliance or vehicle, a sensor, or any device that accesses the network without user input or an expectation (or prediction) of user input to do so. Such can be readily distinguished from user devices (e.g., smart phones) in which it is expected that access to the network will be largely driven by user input.

The type of the subscriber device can also be categorized according to whether the (M2M device) has undergone a certification device. Certification typically involves suitable testing such that it can be known in advance certain details regarding the subscriber device's traffic patterns and/or use of network resources and/or expected behavior. In some embodiments, certification can establish a threshold relating to the risk of the device using network resources or services. In some embodiments, certification can relate to events or use schedules (e.g., time of day of certain activity or the like), a number of devices in a service, an expected geographic location of the subscriber device(s), maintenance procedures, and so on. Knowing this information in advance can be advantageous in determining whether a particular subscriber device is misbehaving or operating in a proper fashion.

However, some subscriber devices may access the network without undergoing certification. It is appreciated that subscriber devices that have not been certified may be more difficult to determine normal behavior and thus may have a higher risk profile than those that have been certified. Subscriber devices that have been through certification can be assigned to certified devices slice(s) 404, while those that have not can be assigned to uncertified device slice(s) 408.

It has been identified that subscriber devices sometimes perform maintenance activities (e.g., updating software or firmware, performing diagnostics, and so forth) that tend to result in a very different resource use profile than other times. As such, subscriber devices that are determined to be performing a type of maintenance activity can be categorized into maintenance slice 406 during those times. All three of these example logical network slices 310 categories (e.g., 404, 406, and 408) are generally deemed to be normal

Furthermore, misbehaving subscriber devices exhibiting malicious activity can be assigned to malicious devices slice(s) 412. In some embodiments behavior that is determined to be suspicious, but potentially not deemed malicious, can be assigned to honeypot slice(s) 414, which can implement an interactive call-flow with the misbehaving subscriber device while also isolating the subscriber device from others. At reference numeral 314, device 300 can determine that a given subscriber device is exhibiting malicious activity, which can be determined based on the satisfaction of a malicious activity criterion (e.g., abnormal signaling activity). Determination 314 can be performed based on monitoring and/or comparing current behavior with predicted behavior. This predicted behavior can be developed from certification or from machine learning techniques for subscriber devices that have not been certified.

In response to determination 314, device 300 can, at reassignment 316, reassign the subscriber device from the first slice (to which it was assigned at reference numeral 312) to a second slice of the logical network slices 310. Hence, it is appreciated that assignment 312 and reassignment 316 can be fluid and ongoing processes (e.g., in response to current behavior). For example, prior to a maintenance cycle, a given subscriber device may be assigned to suitable certified device slice 404 or uncertified device slice 408, then be reassigned to maintenance slice 406 during a software update. Upon completion of the software update, the instant subscriber device can again be reassigned, typically back to slice 404 or 408. Similarly, when or if the behavior of subscriber device becomes malicious or suspicious, then that subscriber device can be removed from the previously assigned protection slice 402 and reassigned to one of the reaction slices 410, where misbehavior does not affect the service of nominally functioning subscriber devices.

Referring now to FIG. 5, a block diagram of system 500 is presented. System 500 illustrates additional aspects or elements of security device 306 in accordance with certain embodiments of this disclosure. For example, as noted previously, security device 306 can include other devices or functionality, which can be discussed in terms of anomaly detection device 308, security slice classifier device 310, and security policy engine device 312.

In some embodiments, protection slices 402 can rely on certain key capabilities of device 300. For example, a capability of detecting misbehaving subscriber devices, which can be provided by anomaly detection device 308. Reference numeral 502 illustrates this concept, which can be accomplished via continuously or frequently monitoring the behavior of subscriber devices. When said behavior sufficiently deviates from expected or predicted behavior, security slice classifier device 310 can reassign the subscriber device from a protection slice 402 to a reaction slice 410. In this example, security slice classifier device 310 might reassign the subscriber device to watch list 508 (which can be similar to honeypot slice(s) 414), to malicious slice 510 (which can be similar to malicious slice(s) 412, or some other appropriate slice. If, for example after a defined time, the subscriber device that is in watch list 508 reverts to nominal behavior, then that subscriber device can rejoin others in protection slice 402. Otherwise, that subscriber device can be reassigned to a reaction slice 410.

In more detail, anomaly detection device 308 can identify devices and classes of devices that are not behaving within acceptable parameters, which can be a function of the type or class of the subscriber device. Thus, anomaly detection device 308 can access profiles (e.g., subscriber and service profiles 506) of classes of devices that include the normal traffic behavior, expected rates of network resource demands, and other relevant metrics. Said profiles can be generated based on device certification or from machine learning techniques for uncertified devices. Irrespective of how a given profile is generated, it should be understood that different profiles, and therefore different criteria for determining a misbehaving device, can exist for different ones of the logical network slices 310. For example, the profile of a subscriber device that is assigned to maintenance slice 406 can be materially distinct from the profile of the same device while assigned to the uncertified device slice 408. Because the profiles are different, the criteria for identifying misbehavior differ as well. It is therefore interesting to note that subscriber device profiles are in some ways more a function of the particular logical network slice 310 to which the subscriber device is currently assigned than the subscriber device itself.

Security slice classifier device 310 can receive as inputs certain outputs of anomaly detection device 308. This input from anomaly detection device 308 can be examined to determine potential misbehaving devices or classes of devices. Security slice classifier 310 can determine if a given subscriber device is behaving as expected or if it is causing potential issues for the network or other devices. As noted previously, such can be accomplished based on a comparison of subscriber and service profiles 506 to network traffic KPIs 504 or some other relevant resource consumption metric.

Security policy engine device 312 can comprise logic to determine what actions are to be taken, if any, in order to limit misbehaving devices from utilizing more network resources than appropriate. Security policy engine device 312 can receive as input output of security slice classifier device 310 as well as network traffic KPI 504, and device IDs 512 of subscriber devices that are assigned to malicious slice 512. Some example actions taken can be to notify 514 the service subscriber, reduce the amount of traffic allowed via a throttle 516 technique, forcing an update 518 of software, firmware, or other code (e.g., if such is determined to be a likely cause of the misbehavior) of the subscriber device, or potentially even blocking the device 520 from utilizing network resources.

In some embodiments, a given subscriber device can be assigned to multiple different slices, based on a type, state, or behavior. If this subscriber device begins to misbehave or malfunction, it is conceivable that the disclosed subject matter can identify the bad behavior in each slice independently. However, provided the misbehavior is identified in a single slice, the misbehaving subscriber device can be removed from all other slices (e.g., protection slices 402) to which it is assigned and reassigned to an appropriate reaction slice 410. Likewise, responses such as those indicated at reference numerals 514, 516, 518, or 520 can be enacted irrespective of whether misbehavior by the subscriber device is detected on only one or a subset of slices to which it is assigned.

### Example Methods

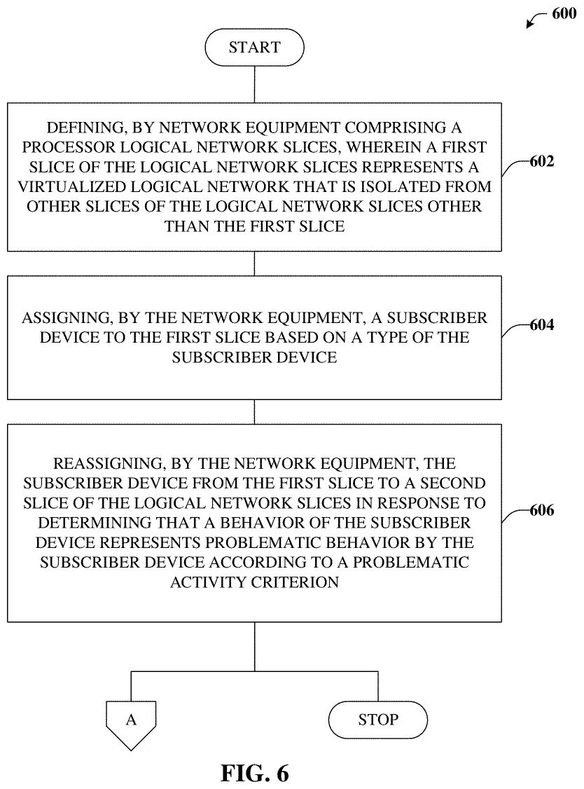

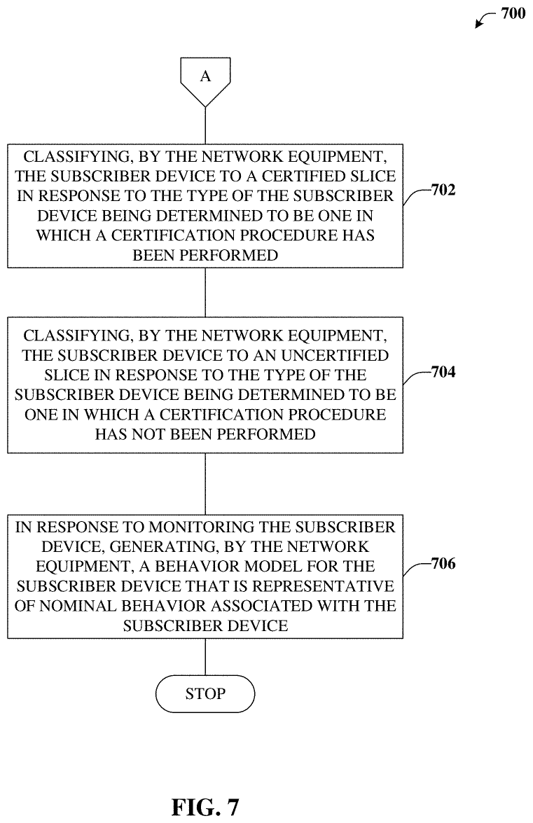

FIGS. 6 and 7 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers.

Turning now to FIG. 6, exemplary method 600 is depicted. Method 600 can provide increased security for a network that has network slicing capabilities in accordance with certain embodiments of this disclosure. For example, at reference numeral 602, network equipment (e.g., device 300) define logical network slices. A first slice of the logical network slices can represent a virtualized logical network that is isolated from other slices of the logical network slices other than the first slice.

At reference numeral 604, the network equipment can assign a subscriber device to the first slice based on a type of the subscriber device. In some embodiments, this assignment can be based on a current role or behavior of the subscriber device.

At reference numeral 608, the network equipment can reassign the subscriber device from the first slice to a second slice of the logical network slices in response to determining that a behavior of the subscriber device represents problematic behavior by the subscriber device according to a problematic activity criterion. Method 600 can stop or proceed to insert A, which is further detailed in connection with FIG. 7.

With reference now to FIG. 7, exemplary method 700 is illustrated. Method 700 can provide for additional elements or aspects in connection with increased security for a network that has network slicing capabilities in accordance with certain embodiments of this disclosure. For example, at reference numeral 702, the network equipment can classify the subscriber device to a certified slice in response to the type of the subscriber device being determined to be one in which a certification procedure has been performed.

At reference numeral 704, the network equipment can classify the subscriber device to an uncertified slice in response to the type of the subscriber device being determined to be one in which a certification procedure has not been performed. At reference numeral 706, the network equipment can generate a behavior model for the subscriber device. This behavior model can be representative of nominal behavior associated with the subscriber device. In some embodiments, the behavior model can be generate in response to monitoring the subscriber device for a period sufficient to learn the normal behavior.

### Example Operating Environments

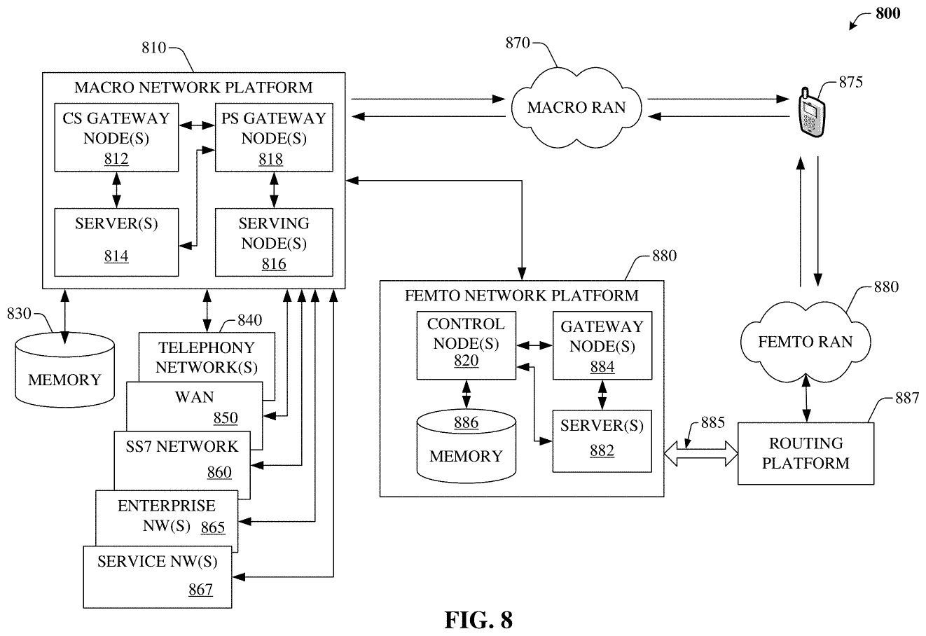

To provide further context for various aspects of the subject specification, FIG. 8 illustrates an example wireless communication environment 800, with associated components that can enable operation of a femtocell enterprise network in accordance with aspects described herein. Wireless communication environment 800 comprises two wireless network platforms: (i) A macro network platform 810 that serves, or facilitates communication with, user equipment 875 via a macro radio access network (RAN) 870. It should be appreciated that in cellular wireless technologies (e.g., 4G, 3GPP UMTS, HSPA, 3GPP LTE, 3GPP UMB, 5G), macro network platform 810 is embodied in a Core Network. (ii) A femto network platform 880, which can provide communication with UE 875 through a femto RAN 890, linked to the femto network platform 880 through a routing platform 887 via backhaul pipe(s) 885. It should be appreciated that femto network platform 880 typically offloads UE 875 from macro network, once UE 875 attaches (e.g., through macro-to-femto handover, or via a scan of channel resources in idle mode) to femto RAN.

It is noted that RAN comprises base station(s), or access point(s), and its associated electronic circuitry and deployment site(s), in addition to a wireless radio link operated in accordance with the base station(s). Accordingly, macro RAN 1370 can comprise various coverage cells, while femto RAN 890 can comprise multiple femto access points or multiple metro cell access points. As mentioned above, it is to be appreciated that deployment density in femto RAN 890 can be substantially higher than in macro RAN 870.

Generally, both macro and femto network platforms 810 and 880 comprise components, e.g., nodes, gateways, interfaces, servers, or platforms, that facilitate both packet-switched (PS) (e.g., internet protocol (IP), Ethernet, frame relay, asynchronous transfer mode (ATM)) and circuit-switched (CS) traffic (e.g., voice and data) and control generation for networked wireless communication. In an aspect of the subject innovation, macro network platform 810 comprises CS gateway node(s) 812 which can interface CS traffic received from legacy networks like telephony network(s) 840 (e.g., public switched telephone network (PSTN), or public land mobile network (PLMN)) or a SS7 network 860. Circuit switched gateway 812 can authorize and authenticate traffic (e.g., voice) arising from such networks. Additionally, CS gateway 812 can access mobility, or roaming, data generated through SS7 network 860; for instance, mobility data stored in a VLR, which can reside in memory 830. Moreover, CS gateway node(s) 812 interfaces CS-based traffic and signaling and gateway node(s) 818. As an example, in a 3GPP UMTS network, gateway node(s) 818 can be embodied in gateway GPRS support node(s) (GGSN).

In addition to receiving and processing CS-switched traffic and signaling, gateway node(s) 818 can authorize and authenticate PS-based data sessions with served (e.g., through macro RAN) wireless devices. Data sessions can comprise traffic exchange with networks external to the macro network platform 810, like wide area network(s) (WANs) 850; it should be appreciated that local area network(s) (LANs) can also be interfaced with macro network platform 810 through gateway node(s) 818. Gateway node(s) 818 generates packet data contexts when a data session is established. To that end, in an aspect, gateway node(s) 818 can comprise a tunnel interface (e.g., tunnel termination gateway (TTG) in 3GPP UMTS network(s); not shown) which can facilitate packetized communication with disparate wireless network(s), such as Wi-Fi networks. It should be further appreciated that the packetized communication can comprise multiple flows that can be generated through server(s) 814. It is to be noted that in 3GPP UMTS network(s), gateway node(s) 818 (e.g., GGSN) and tunnel interface (e.g., TTG) comprise a packet data gateway (PDG).

Macro network platform 810 also comprises serving node(s) 816 that convey the various packetized flows of information or data streams, received through gateway node(s) 818. As an example, in a 3GPP UMTS network, serving node(s) can be embodied in serving GPRS support node(s) (SGSN).

As indicated above, server(s) 814 in macro network platform 810 can execute numerous applications (e.g., location services, online gaming, wireless banking, wireless device management . . . ) that generate multiple disparate packetized data streams or flows, and manage (e.g., schedule, queue, format . . . ) such flows. Such application(s), for example can comprise add-on features to standard services provided by macro network platform 810. Data streams can be conveyed to gateway node(s) 818 for authorization/authentication and initiation of a data session, and to serving node(s) 816 for communication thereafter. Server(s) 814 can also effect security (e.g., implement one or more firewalls) of macro network platform 810 to ensure network's operation and data integrity in addition to authorization and authentication procedures that CS gateway node(s) 812 and gateway node(s) 818 can enact. Moreover, server(s) 814 can provision services from external network(s), e.g., WAN 850, or Global Positioning System (GPS) network(s) (not shown). It is to be noted that server(s) 814 can comprise one or more processor configured to confer at least in part the functionality of macro network platform 810. To that end, the one or more processor can execute code instructions stored in memory 830, for example.

In example wireless environment 800, memory 830 stores information related to operation of macro network platform 810. Information can comprise business data associated with subscribers; market plans and strategies, e.g., promotional campaigns, business partnerships; operational data for mobile devices served through macro network platform; service and privacy policies; end-user service logs for law enforcement; and so forth. Memory 830 can also store information from at least one of telephony network(s) 840, WAN(s) 850, or SS7 network 860, enterprise NW(s) 865, or service NW(s) 867.

Femto gateway node(s) 884 have substantially the same functionality as PS gateway node(s) 818. Additionally, femto gateway node(s) 884 can also comprise substantially all functionality of serving node(s) 816. In an aspect, femto gateway node(s) 884 facilitates handover resolution, e.g., assessment and execution. Further, control node(s) 820 can receive handover requests and relay them to a handover component (not shown) via gateway node(s) 884. According to an aspect, control node(s) 820 can support RNC capabilities.

Server(s) 882 have substantially the same functionality as described in connection with server(s) 814. In an aspect, server(s) 882 can execute multiple application(s) that provide service (e.g., voice and data) to wireless devices served through femto RAN 890. Server(s) 882 can also provide security features to femto network platform. In addition, server(s) 882 can manage (e.g., schedule, queue, format . . . ) substantially all packetized flows (e.g., IP-based) it generates in addition to data received from macro network platform 810. It is to be noted that server(s) 882 can comprise one or more processor configured to confer at least in part the functionality of macro network platform 810. To that end, the one or more processor can execute code instructions stored in memory 886, for example.

Memory 886 can comprise information relevant to operation of the various components of femto network platform 880. For example, operational information that can be stored in memory 886 can comprise, but is not limited to, subscriber information; contracted services; maintenance and service records; femto cell configuration (e.g., devices served through femto RAN 890; access control lists, or white lists); service policies and specifications; privacy policies; add-on features; and so forth.

It is noted that femto network platform 880 and macro network platform 810 can be functionally connected through one or more reference link(s) or reference interface(s). In addition, femto network platform 880 can be functionally coupled directly (not illustrated) to one or more of external network(s) 840, 850, 860, 865 or 867. Reference link(s) or interface(s) can functionally link at least one of gateway node(s) 884 or server(s) 886 to the one or more external networks 840, 850, 860, 865 or 867.

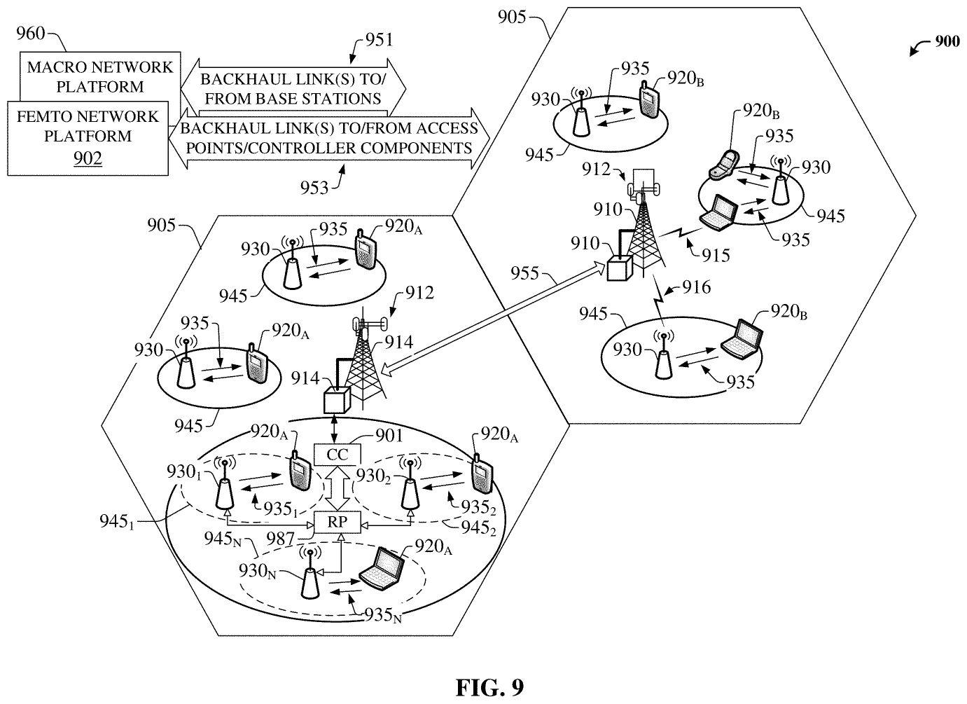

FIG. 9 illustrates a wireless environment that comprises macro cells and femtocells for wireless coverage in accordance with aspects described herein. In wireless environment 905, two areas represent “macro” cell coverage; each macro cell is served by a base station 910. It can be appreciated that macro cell coverage area 905 and base station 910 can comprise functionality, as more fully described herein, for example, with regard to system 900. Macro coverage is generally intended to serve mobile wireless devices, like UE 920_{A}, 920_{B}, in outdoors locations. An over-the-air (OTA) wireless link 935 provides such coverage, the wireless link 935 comprises a downlink (DL) and an uplink (UL), and utilizes a predetermined band, licensed or unlicensed, of the radio frequency (RF) spectrum. As an example, UE 920A, 920B can be a 3GPP Universal Mobile Telecommunication System (UMTS) mobile phone. It is noted that a set of base stations, its associated electronics, circuitry or components, base stations control component(s), and wireless links operated in accordance to respective base stations in the set of base stations form a radio access network (RAN). In addition, base station 910 communicates via backhaul link(s) 951 with a macro network platform 960, which in cellular wireless technologies (e.g., 3rd Generation Partnership Project (3GPP) Universal Mobile Telecommunication System (UMTS), Global System for Mobile Communication (GSM)) represents a core network.

In an aspect, macro network platform 960 controls a set of base stations 910 that serve either respective cells or a number of sectors within such cells. Base station 910 comprises radio equipment 914 for operation in one or more radio technologies, and a set of antennas 912 (e.g., smart antennas, microwave antennas, satellite dish(es) . . . ) that can serve one or more sectors within a macro cell 905. It is noted that a set of radio network control node(s), which can be a part of macro network platform 960; a set of base stations (e.g., Node B 910) that serve a set of macro cells 905; electronics, circuitry or components associated with the base stations in the set of base stations; a set of respective OTA wireless links (e.g., links 915 or 916) operated in accordance to a radio technology through the base stations; and backhaul link(s) 955 and 951 form a macro radio access network (RAN). Macro network platform 960 also communicates with other base stations (not shown) that serve other cells (not shown). Backhaul link(s) 951 or 953 can comprise a wired backbone link (e.g., optical fiber backbone, twisted-pair line, T1/E1 phone line, a digital subscriber line (DSL) either synchronous or asynchronous, an asymmetric ADSL, or a coaxial cable . . . ) or a wireless (e.g., LoS or non-LoS) backbone link. Backhaul pipe(s) 955 link disparate base stations 910. According to an aspect, backhaul link 953 can connect multiple femto access points 930 and/or controller components (CC) 901 to the femto network platform 902. In one example, multiple femto APs can be connected to a routing platform (RP) 987, which in turn can be connect to a controller component (CC) 901. Typically, the information from UEs 920_{A} can be routed by the RP 987, for example, internally, to another UE 920_{A} connected to a disparate femto AP connected to the RP 987, or, externally, to the femto network platform 902 via the CC 901, as discussed in detail supra.

In wireless environment 905, within one or more macro cell(s) 905, a set of femtocells 945 served by respective femto access points (APs) 930 can be deployed. It can be appreciated that, aspects of the subject innovation can be geared to femtocell deployments with substantive femto AP density, e.g., 9⁴-10⁷ femto APs 930 per base station 910. According to an aspect, a set of femto access points 930₁-930_{N}, with N a natural number, can be functionally connected to a routing platform 987, which can be functionally coupled to a controller component 901. The controller component 901 can be operationally linked to the femto network platform 902 by employing backhaul link(s) 953. Accordingly, UE 920_{A} connected to femto APs 930₁-930_{N} can communicate internally within the femto enterprise via the routing platform (RP) 987 and/or can also communicate with the femto network platform 902 via the RP 987, controller component 901 and the backhaul link(s) 953. It can be appreciated that although only one femto enterprise is depicted in FIG. 9, multiple femto enterprise networks can be deployed within a macro cell 905.

It is noted that while various aspects, features, or advantages described herein have been illustrated through femto access point(s) and associated femto coverage, such aspects and features also can be exploited for home access point(s) (HAPs) that provide wireless coverage through substantially any, or any, disparate telecommunication technologies, such as for example Wi-Fi (wireless fidelity) or picocell telecommunication. Additionally, aspects, features, or advantages of the subject innovation can be exploited in substantially any wireless telecommunication, or radio, technology; for example, Wi-Fi, Worldwide Interoperability for Microwave Access (WiMAX), Enhanced General Packet Radio Service (Enhanced GPRS), 3GPP LTE, 3GPP2 UMB, 3GPP UMTS, HSPA, HSDPA, HSUPA, or LTE Advanced. Moreover, substantially all aspects of the subject innovation can comprise legacy telecommunication technologies.

With respect to FIG. 9, in example embodiment 900, base station AP 910 can receive and transmit signal(s) (e.g., traffic and control signals) from and to wireless devices, access terminals, wireless ports and routers, etc., through a set of antennas 912₁-912_{N}. It should be appreciated that while antennas 912₁-912_{N} are a part of communication platform 925, which comprises electronic components and associated circuitry that provides for processing and manipulating of received signal(s) (e.g., a packet flow) and signal(s) (e.g., a broadcast control channel) to be transmitted. In an aspect, communication platform 925 comprises a transmitter/receiver (e.g., a transceiver) 966 that can convert signal(s) from analog format to digital format upon reception, and from digital format to analog format upon transmission. In addition, receiver/transmitter 966 can divide a single data stream into multiple, parallel data streams, or perform the reciprocal operation. Coupled to transceiver 966 is a multiplexer/demultiplexer 967 that facilitates manipulation of signal in time and frequency space. Electronic component 967 can multiplex information (data/traffic and control/signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition, mux/demux component 967 can scramble and spread information (e.g., codes) according to substantially any code known in the art; e.g., Hadamard-Walsh codes, Baker codes, Kasami codes, polyphase codes, and so on. A modulator/demodulator 968 is also a part of operational group 925, and can modulate information according to multiple modulation techniques, such as frequency modulation, amplitude modulation (e.g., M-ary quadrature amplitude modulation (QAM), with M a positive integer), phase-shift keying (PSK), and the like.

Referring now to FIG. 10, there is illustrated a block diagram of an exemplary computer system operable to execute the disclosed architecture. In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This comprises at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

What has been described above comprises examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

As used in this application, the terms “system,” “component,” “interface,” and the like are generally intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. These components also can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. An interface can comprise input/output (I/O) components as well as associated processor, application, and/or API components.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from by a computing device.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory. In addition, memory components or memory elements can be removable or stationary. Moreover, memory can be internal or external to a device or component, or removable or stationary. Memory can comprise various types of media that are readable by a computer, such as hard-disc drives, zip drives, magnetic cassettes, flash memory cards or other types of memory cards, cartridges, or the like.

By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments comprise a system as well as a computer-readable medium having computer-executable instructions for performing the acts and/or events of the various methods.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

What is claimed is:

1. A device, comprising:
a processor configured to leverage a network slicing capability of network equipment to increase network security of the network equipment according to a defined security criterion; and
a memory that stores executable instructions that, when executed by the processor, facilitate performance of operations, comprising:
defining logical network slices, wherein a first slice of the logical network slices represents a virtualized logical network that is isolated from, and independent of, other slices of the logical network slices other than the first slice;
assigning a subscriber device to the first slice based on a type of the subscriber device; and
in response to determining that a behavior of the subscriber device satisfies a malicious activity criterion indicative of malicious activity, reassigning the subscriber device from the first slice to a second slice of the other slices.

2. The device of claim 1, wherein the subscriber device is a machine-to-machine device, and wherein the subscriber device utilizes the network equipment without user input or predicted user input.

3. The device of claim 1, wherein defining the logical network slices comprises defining a group of slices that facilitate communication of a certified subscriber device with respect to which a certification procedure relating to expected behavior of the certified subscriber device has been performed.

4. The device of claim 1, wherein defining the logical network slices comprises defining a group of slices that facilitate communication of an uncertified subscriber device with respect to which a certification procedure relating to expected behavior of the certified subscriber device has not been performed.

5. The device of claim 1, wherein defining the logical network slices comprises defining a group of slices that facilitate communication of the subscriber device during a maintenance procedure.

6. The device of claim 1, wherein defining the logical network slices comprises defining a group of slices that are able to facilitate communication of the subscriber device in response to the malicious activity being determined.

7. The device of claim 1, wherein the operations further comprise determining that the behavior of the subscriber device satisfies the malicious activity criterion in response to performing an anomaly detection procedure.

8. The device of claim 7, wherein the anomaly detection procedure comprises:
in response to determining that the behavior of the subscriber device satisfies a suspicious activity criterion indicative of suspicious activity, monitoring the behavior for a defined monitoring period; and
determining the malicious activity criterion is satisfied in response to the suspicious activity criterion being maintained for the defined period and that the suspicious activity is determined to affect operation of other subscriber devices, other than the subscriber device.

9. The device of claim 7, wherein the anomaly detection procedure comprises comparing the behavior of the subscriber device to a predicted behavior of the subscriber device.

10. The device of claim 9, wherein the predicted behavior of the subscriber device is determined based on an output from a certification procedure.

11. The device of claim 9, wherein the predicted behavior of the subscriber device is determined based on the type of the subscriber device.

12. The device of claim 9, wherein the predicted behavior of the subscriber device is determined based on a behavior learning model representative of nominal behavior of the subscriber device that is learned over a defined learning period.

13. The device of claim 12, wherein the operations further comprise generating the behavior learning model in response to a determination that the type of the subscriber device has not been subjected to a certification procedure.

14. A non-transitory machine-readable medium, comprising executable instructions that, when executed by a processor, facilitate performance of operations, comprising, comprising:
defining logical network slices, wherein a slice of the logical network slices represents a virtualized logical network that is isolated from other slices of the logical network slices;
assigning a subscriber device to the slice based on a type of the subscriber device; and
in response to determining that a behavior of the subscriber device satisfies a suspicious activity criterion that indicates a presence of suspicious activity, reassigning the subscriber device from the slice to at least one of the other slices.

15. The non-transitory machine-readable medium of claim 14, wherein the at least one of the other slices is determined to comprise a malicious activity slice for devices exhibiting malicious behavior.

16. The non-transitory machine-readable medium of claim 14, wherein the at least one of the other slices is determined to comprise a honeypot slice for devices exhibiting suspicious behavior.

17. A method, comprising:
defining, by network equipment comprising a processor, logical network slices, wherein a first slice of the logical network slices represents a virtualized logical network that is isolated from other slices of the logical network slices other than the first slice;
assigning, by the network equipment, a subscriber device to the first slice based on a type of the subscriber device; and
reassigning, by the network equipment, the subscriber device from the first slice to a second slice of the logical network slices in response to determining that a behavior of the subscriber device represents problematic behavior by the subscriber device according to a problematic activity criterion.

18. The method of claim 17, further comprising classifying, by the network equipment, the subscriber device to a certified slice in response to the type of the subscriber device being determined to be one in which a certification procedure has been performed.

19. The method of claim 17, further comprising classifying, by the network equipment, the subscriber device to an uncertified slice in response to the type of the subscriber device being determined to be one in which a certification procedure has not been performed.

20. The method of claim 19, further comprising in response to monitoring the subscriber device, generating, by the network equipment, a behavior model for the subscriber device that is representative of nominal behavior associated with the subscriber device.
